(19) United States
(12) Patent Application Publication
(10) Pub. No.: US 2002/0030675 A1
(43) Pub. Date: Mar. 14, 2002

(54) Image display control apparatus

(76) Inventor: Tomoaki Kawai, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/947,756

(22) Filed: Sep. 7, 2001

(30) Foreign Application Priority Data
Sep. 12, 2000 (JP) 2000-276731

(51) Int. Cl. G09G 5/00

(52) U.S. Cl. 345/204

(57) ABSTRACT

An image display control system includes a display image generating block for generating a display image from three-dimensional image data and also includes a device information acquiring block for acquiring device information associated with a display device. The display image generating block generates the display image in an image format according to device information acquired by the device information acquiring block thereby allowing the image to be displayed on a stereoscopic display device regardless of the stereoscopic image format of the display device.

### BACKGROUND OF THE INVENTION

1. Field of the Invention

The present invention relates to an image display controlling apparatus, an image display system, and a method of displaying image data.

2. Description of the Related Art

Conventionally, three-dimensional (3D) data is dealt with in various applications including computer graphics, medical images such as CT (Computer Tomography) or MRI (Magnetic Resonance Imaging), molecular modeling, two-dimensional (2D) CAD (Computer Aided Design), and scientific visualization. In some cases, an image is displayed using an image display device capable of displaying an image in a stereoscopic manner. One known technique which is practically used to achieve stereoscopic vision is to display images on image display devices so that left and right images having parallax are viewed by left and right eyes, respectively.

In this type of image display apparatuses, stereoscopic vision is generally achieved by using the property that the depth of an object is visually perceived by human eyes on the basis of the angle of convergence, that is, an angle between two lines of sight corresponding to the two eyes. More specifically, when the angle of convergence is large, an object is perceived as locating nearby, while the object is perceived as locating far away when the angle of convergence is small.

Two-viewpoint image data can be generated using the principle of the stereoscopic vision achieved by the angle of convergence. Specific examples include a pair of stereoscopic images taken by a two-lens stereoscopic camera, and a pair of stereoscopic two-viewpoint images generated by rendering 3D model data onto a 2D plane.

Various techniques are practically used to display two-viewpoint images so as to provide stereoscopic vision. They include an HMD (Head Mounted Display) technique in which images displayed on two different liquid crystal panels are viewed by left and right eyes, respectively; a liquid crystal shutter technique in which left and right images are alternately displayed on a CRT and liquid crystal shutter eyeglasses are operated in synchronization with the images so that the left and right images are respectively viewed by left and right eyes; a stereoscopic projection technique in which left and right images are projected onto a screen using differently polarized light and the left and right images are separated from each other via polarizing glasses having left and right eyepieces which polarize light differently; and a direct-view-type display technique in which an image is displayed on a display formed of a combination of a liquid crystal panel and lenticular lenses so that, when the image is viewed from a particular location without wearing glasses, the image is separated into left and right images corresponding to the left and right eyes.

FIG. 17 illustrates the principle of displaying image data using the HMD technique.

In general, as shown in FIG. 17A, when an object is viewed by left and right eyes 101 and 102, the angle of convergence θ of an object 103 which is a relatively large distance apart is smaller than the angle of convergence θ of an object 104 at a smaller distance.

Therefore, as shown in FIG. 17B, stereoscopic vision can be achieved by disposing a left-eye liquid crystal panel 105 and a right-eye liquid crystal panel 106 in front of the left and right eyes 101 and 102, respectively, and displaying projected images of the object 103 and the object 104 so that an image such as that denoted by A is viewed by the left eye 101 and an image such as that denoted by B is viewed by the right eye 102. If the liquid crystal panels 105 and 106 viewed by the left and right eyes 101 and 102 at the same time, the images of the objects 103 and 104 are viewed as if they were actually present at the same locations as those shown in FIG. 17A. In the HMD, as described above, the left and right images are viewed only by the corresponding eyes thereby achieving stereoscopic vision.

In this stereoscopic image display technique, as described above, each of left and right images is viewed only by corresponding one of two eyes. However, there are a large number of data formats for a pair of stereoscopic images, and it is required to generate a pair of stereoscopic images in accordance with a specified data format to achieve stereoscopic vision.

More specifically, formats of stereoscopic image data include a two-input format, a line-sequential format, a page-flipping format, an upper-and-lower two-image format, a left-and-right two-image format, and a VRML (Virtual Reality Modeling Language) format.

In the two-input format, as shown in FIG. 18A, a left image L and a right image R are separately generated and displayed. In the line-sequential format, as shown in FIG. 18B, odd-numbered lines and even-numbered lines of pixels of the left image L and the right image R are extracted and the left image L and the right image R are alternately displayed line by line. In the page-flipping format, as shown in FIG. 18C, a left image L and a right image R are displayed alternately in terms of time. In the upper-and-lower two-image format, as shown in FIG. 18D, a left image L and a right image R each having a vertical resolution one-half the normal resolution are respectively placed at upper and lower locations in a normal single-image size. In the left-and-right two-image format, as shown in FIG. 18E, a left image L and a right image R each having a vertical resolution one-half the normal resolution are respectively placed at left and right locations in a normal single-image size. In the VRML format, an image based on virtual reality model data is displayed. In the 2D format, an image is displayed not in a stereoscopic manner but is displayed as a two-dimensional plane image.

In order to use the stereoscopic image display device described above, it is needed to generate a pair of stereoscopic images having an optimum parallax between left and right eyes. However, the optimum parallax is different depending upon the stereoscopic image display format and the screen size.

FIG. 19 illustrates an example of a conventional stereoscopic image displaying device of a direct view type which uses lenticular lenses. In this direct-view-type display, first and second lenticular lenses 110 and 111 are disposed between a display device 107 such as a liquid crystal display device and a mask plate 109 having a checker mask pattern 108, and a backlight 112 is disposed at the back of the mask plate 109.

In this direct-view-type display, an optimum location for viewing a stereoscopic image is determined by the size of the first and second lenticular lenses 110 and 111. For example, in the case of a 15 inch display, a location 60 cm apart from its screen is an optimum viewing location.

In some HMDs, an optical configuration is designed within a limited physical space so that an image is viewed as if the image were displayed on a 50 inch display located 2 m apart. That is, the optical configuration can be designed so that the optical distance from an eye to a display screen can be set variously. However, in any case, the angle of convergence varies depending upon the type of the display device and the designed value thereof.

In the case where the location of an object varies in the depth direction, even if the angle of convergence varies depending upon the location of the object in the depth direction, the focusing points of eyes are always located on the display screen, and thus the eyes are needed to view the images of the object in an unnatural manner which is different from the manner in which an actual object is viewed by the eyes. That is, when the parallax between the left and right images is too large, the images cannot be mixed together into stereoscopic vision. For example, in the case of a 15 inch direct-view-type display designed to be viewed from a location 60 cm apart from its display screen, it is empirically known that left and right images cannot be mixed together into stereoscopic vision if the parallax between left and right images is greater than 3 cm as measured on the screen. However, in the HMD designed such that images are displayed as if they were displayed on a 50 inch display device 2 m apart, the maximum allowable parallax is different from that for the direct-view-type display device. That is, the maximum allowable parallax depends upon the type of the stereoscopic display device.

As described above, because the stereoscopic image format in which stereoscopic image data is described is different depending upon the stereoscopic image display device, when a pair of stereoscopic images is generated from 3D model data by means of rendering using application software, the application software is designed to output image data in a specified particular format. Thus, when a specific display device is given, it is required to use particular application software designed for that specific display device.

Even when images are represented in the same stereoscopic image format using the same application software, the optimum parallax varies depending upon the screen size and the specific stereoscopic display device, and thus it is required to manually set various parameters in the application software, depending upon the display device. Thus, a user has to do complicated tasks.

When image data is taken by a stereoscopic two-lens camera and is displayed on various display devices so as to achieve stereoscopic vision, it is required to set the baseline length (distance between the two lenses of the two-lens camera) and the angle of convergence to optimum values depending upon the image format of the display device, the screen size, and the distance between a subject and the camera. To this end, a user needs to adjust the baseline length and the angle of convergence to optimum values on the basis of empirically obtained knowledge and skills, depending upon the type and the characteristics of the display device and the distance between a subject and the camera. This is inconvenient for the user.

Furthermore, when image data taken by the two-lens camera is displayed on a stereoscopic display device so as to achieve stereoscopic vision, the image data format allowed to be employed varies depending upon the specific display device. Therefore, it is required to install special hardware designed for use with the specific display device or it is required to convert the image data into a format which matches the display device.

### SUMMARY OF THE INVENTION

In view of the problems described above, it is an object of the present invention to provide an image display control system capable of displaying a stereoscopic image in an optimum manner regardless of the characteristics of a stereoscopic display device.

It is another object of the present invention to provide an image display control system capable of flexibly dealing with various types of stereoscopic display devices designed to display images in various stereoscopic image formats.

According to an aspect of the present invention, to achieve the above objects, there is provided an image display apparatus comprising display image generating means for generating display image from three-dimensional image data; and device information acquiring means for acquiring device information associated with the display device, wherein the display image generating means generates the display image in an image format corresponding to the device information acquired by the device information acquiring means.

According to an aspect of the present invention, to achieve the above objects, there is provided an image display apparatus comprising a camera device for taking image data; device information acquiring means for acquiring device information associated with a display device, and image-taking information acquiring means for acquiring image-taking information corresponding to the device information, wherein the display image generating means generates a display image in accordance with the imagetaking information acquired by the image-taking information acquiring means.

Further objects, features and advantages of the present invention will become apparent from the following description of the preferred embodiments with reference to the attached drawings.

### BRIEF DESCRIPTION OF THE DRAWINGS

FIG. 1 is a diagram illustrating a first embodiment of a stereoscopic image system according to the present invention;

FIG. 2 is a table illustrating stereoscopic image formats;

FIG. 3 is a diagram illustrating packet formats of packets transmitted between a database client and a 3D database server;

FIG. 4 is a diagram illustrating a format of display device information;

FIG. 5 is a diagram illustrating a format of image generation information;

FIG. 6 is a flow chart illustrating an operation of a 3D database server;

FIG. 7 is a diagram illustrating a rendering process;

FIG. 8 is a flow chart illustrating an operation of a database client;

FIG. 9 is a block diagram illustrating main parts of a first modification of the first embodiment;

FIG. 10 is a block diagram illustrating a second modification of the first embodiment;

FIG. 11 is a diagram illustrating main portions of a packet format of a packet transmitted between a database client and a 3D database server, according to the second modification;

FIG. 12 is a diagram illustrating a second embodiment of a stereoscopic image system according to the present invention;

FIG. 13 is a diagram illustrating packet formats of packets transmitted between a database client and a 3D database server, according to the second embodiment;

FIG. 14 is a diagram illustrating a format of camera capability information;

FIG. 15 is a flow chart illustrating an operation of a 3D camera server;

FIG. 16 is a flow chart illustrating an operation of a database client;

FIG. 17 is a diagram illustrating the principle of stereoscopic vision;

FIG. 18 is a diagram illustrating practical manners in which a stereoscopic image is displayed; and

FIG. 19 is a perspective view of a conventional direct-view-type display using lenticular lenses.

### DESCRIPTION OF THE PREFERRED EMBODIMENTS

Embodiments of the present invention are described below with reference to the accompanying drawings.

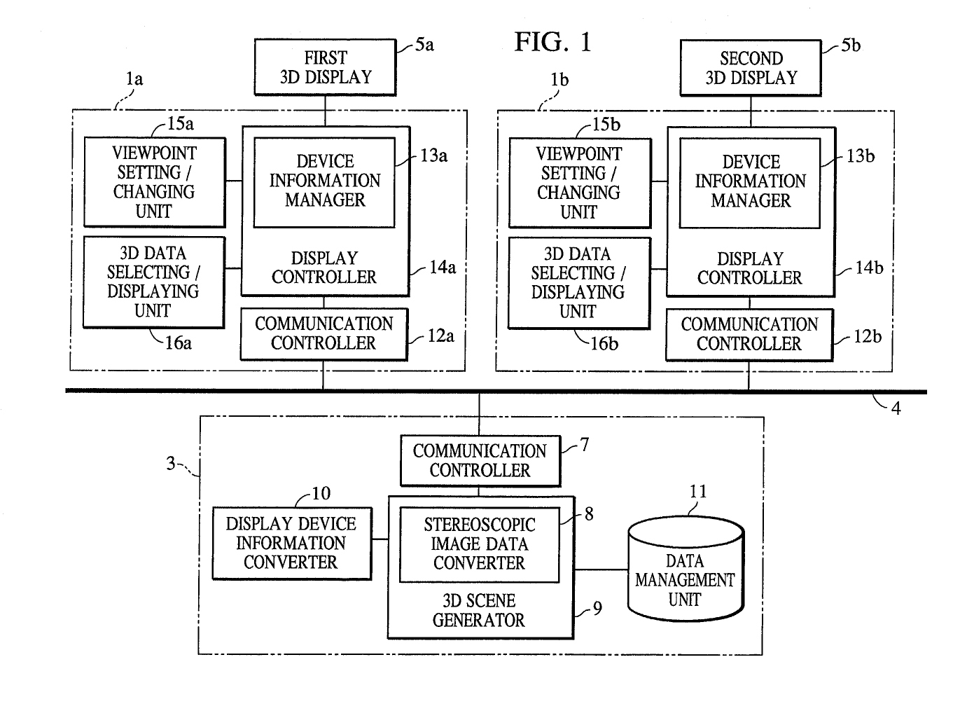

FIG. 1 is a block diagram illustrating an embodiment of an image display system according to the present invention. In this image display system, first and second database clients 1a and 1b and a 3D database server 3 are connected to each other via a network 4. The first and second database clients 1a and 1b are connected to first and second stereoscopic image displays (hereinafter, referred to as 3D displays) 5a and 5b, respectively, so as to control the first and second 3D displays 5a and 5b. The fist and second 3D displays 5a and 5b display stereoscopic image data in stereoscopic image formats which are different from each other.

As for the first and second 3D display devices 5a and 5b, various types of devices such as an HMD, a direct-view-type display, a liquid crystal shutter display, and a stereoscopic projectors may be employed. The network 4 is not limited to a particular type as long as it has a bandwidth large enough to transmit data as will be described later.

The 3D database server 3 includes a communication controller 7 for receiving a request packet from the first database client 1a or the second database client 1b and interpreting the received request packet, a display device information converter 10 for converting display device information into image generation information, a 3D scene generator 9 including a stereoscopic image data converter 8 for converting generated image data into a stereoscopic image format, and a data management unit 11 for storing the data generated by the 3D scene generator 9. The 3D database server 3 renders 3D scene data into a form optimum for use by each of the first and second database clients 1a and 1b and transmits the resultant 3D scene data to the first database client 1a or the second database client 1b.

Each of the first and second database clients 1a and 1b includes a communication controller 12a or 12b for controlling communication with the 3D database server 3 via the network 4, a display controller 14a or 14b including a device information manager 13a or 13b for managing device information, a viewpoint setting/changing unit 15a or 15b for setting/changing a viewpoint, and a 3D data selecting/displaying unit 16a or 16b for displaying 3D data scenes in the form of a list thereby allowing a 3D data scene to be selected.

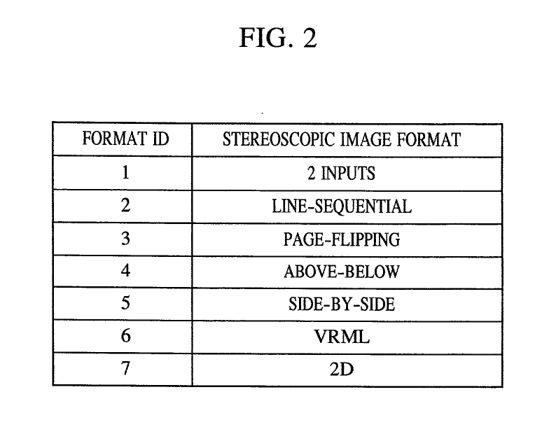

FIG. 2 illustrates a table representing stereoscopic image formats. In this table, a format ID is assigned to each stereoscopic image format. One of the data IDs is written in a data response packet, which will be described later, and the data response packet is transmitted from the 3D database server 3 to the first or second database client 1a or 1b.

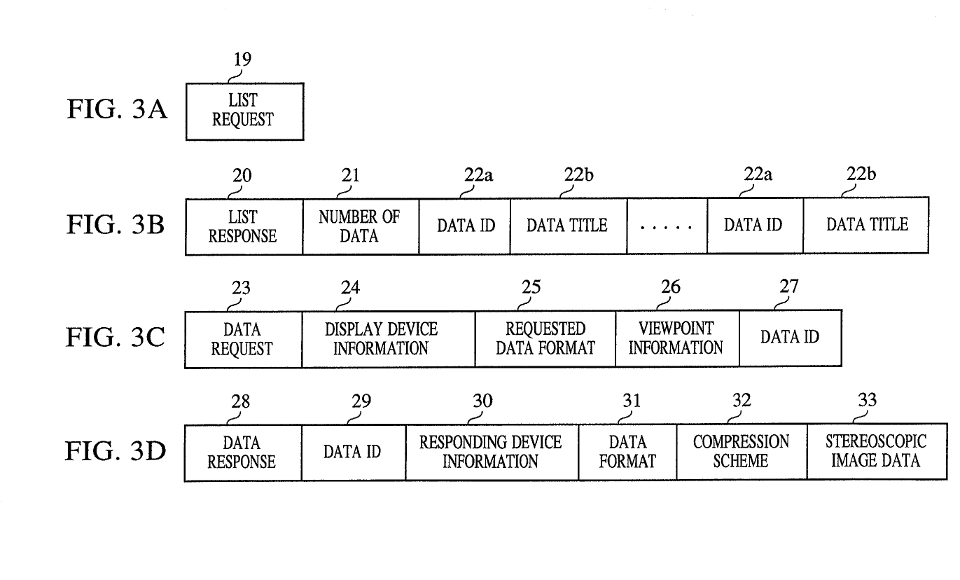

FIG. 3 illustrates packet formats of request and response packets transmitted between the first and second database clients 1a and 1b and the 3D database server 3.

FIG. 3A illustrates a list request packet. The first or second database client 1a or 1b transmits a list request packet 19 to the 3D database server 3 to request the 3D database server 3 to transmit a list of 3D data stored in the data management unit 11 of the 3D database server 3.

FIG. 3B illustrates a packet format of a response packet which is returned in response to the list request 19. The response packet includes fields for describing a list response 20 indicating the packet type and a plurality of sets of data ID 22a and a 3D data title 22b, wherein the number of sets is written in a field of “number of data” 21. As will be described later, the content of the list is stored in the database client 1a or 1b so that it can be used to acquire a data ID corresponding to a data title when a data request packet, which will be described later, is issued.

FIG. 3C illustrates a packet format of a data request packet used to request 3D data specified by a data ID 27, wherein the viewpoint is specified by the data described in the field of viewpoint information 26, the information about the database client 1a or 1b is described in the field of display device information 24, and an optimum data format is specified by the data described in the field of requested data format 25.

FIG. 3D illustrates a data response packet including a rendered stereoscopic image data, which is returned by the 3D database server 3 in response to the data request packet. In the data response packet, a data ID 29, response device information 30 corresponding to the display device information, a data format (format ID corresponding to the stereoscopic image format shown in FIG. 3), a compression scheme 32, and stereoscopic image data 33 are described. Herein, an arbitrary compression scheme such as a JPEG scheme or a RLE scheme may be employed.

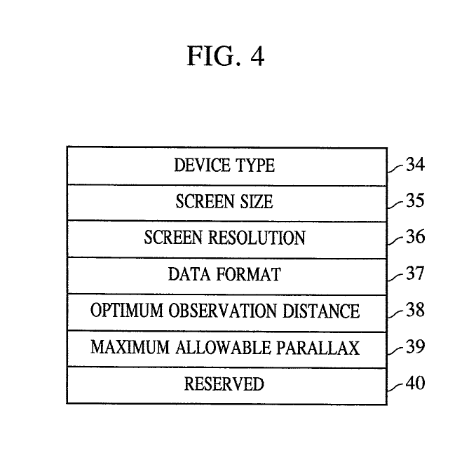

FIG. 4 illustrates a format of the display device information 24.

A device type ID (identifier) is described in a field of “device type” 34 to specify the type of a display device such as an HMD, a direct-view-type display, a liquid crystal shutter glasses, a polarizing light projector, or a 2D monitor. In the field of “screen size” 35, the diagonal length of a screen is described in units of inches. In the field of “screen resolution” 36, the number of pixels as measured along the horizontal direction × vertical direction is described. For example, in the case of a display according to the VGA standard, which is one of the display standards established by IBM in the USA, the number of pixels is described as 640 ×480 in the field of screen resolution 36. The field of “data format” 37 is used to describe a format ID corresponding to a stereoscopic image format.

In the field of “optimum observation distance”, a distance from the screen which is optimum for 3D observation is described. Note that the optimum observation distance indicates not a physical length but an optical length (optical path length) because in some cases, such as in an HMD, the optical length from eyes to the screen is optically lengthened using a prism or a mirror.

In the field of “maximum allowable parallax” 39, the maximum parallax which allows stereoscopic vision to be obtained from left and right images, that is, the maximum distance between corresponding points in left and right images, which allows those points to be mixed into a stereoscopic image, is described by the number of dots on the screen. If the parallax between left and right images is greater than this number of dots, the left and right images cannot be mixed into a stereoscopic-vision image. A reserved field 40 is used to describe other important information such as information as to whether switching between 2D and 3D formats is allowed.

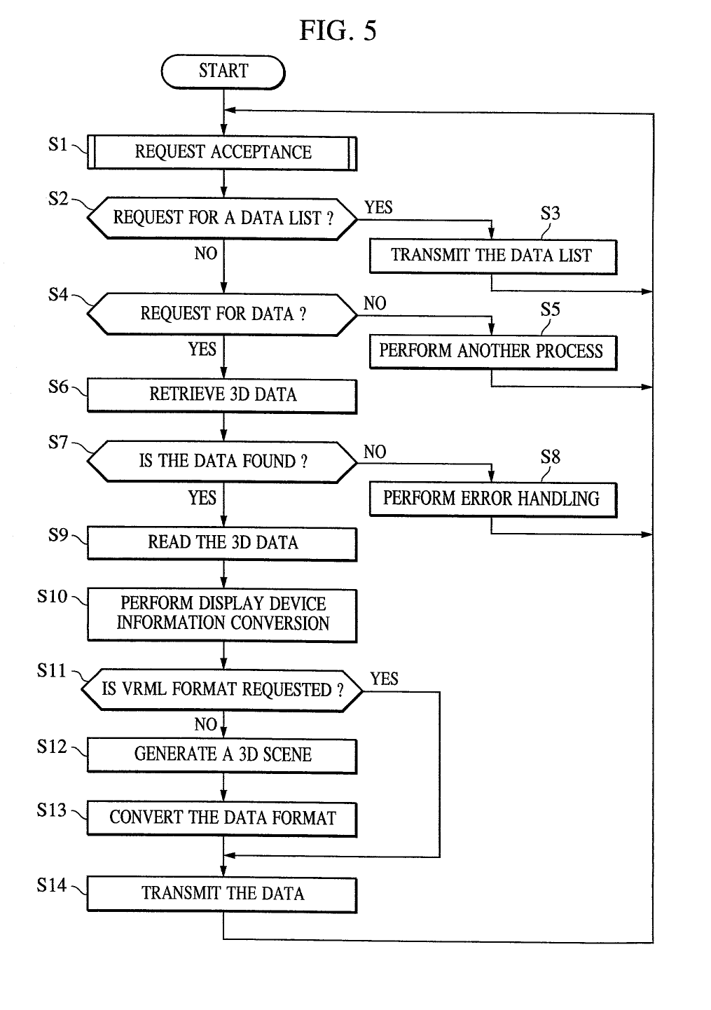

FIG. 5 is a flow chart illustrating an operation performed by the 3D database server 3.

In step S1, a data list request packet is accepted. If, in step S2, it is determined that a list request 19 is received from the first or second database client 1a or 1b, the process proceeds to step S3. In step S3, and a list describing data IDs and data titles of 3D scene data stored in the data management unit 11 is extracted and a list response packet is returned to the first or second database client 1a or 1b.

In the case where the decision in step S2 is negative (no), the process proceeds to step S4 to further determine whether a data request packet is received. If the answer in step S4 is no, the process proceeds to step S5 to perform another process. However, if the answer in step S4 is positive (yes), the process proceeds to step S6 to retrieve 3D data stored in the data management unit 11. In the next step S7, it is determined whether 3D scene corresponding to a data ID exists. If the answer is negative (no), the process proceeds to step S8 and performs an error handling routine. However, if the answer in S7 is affirmative (yes), the 3D scene is read from the data management unit 11 to the 3D scene generator 9. Thereafter, in step S10, the display device information converter 10 generates image generation information on the basis of the display device information 24 described in the data request packet.

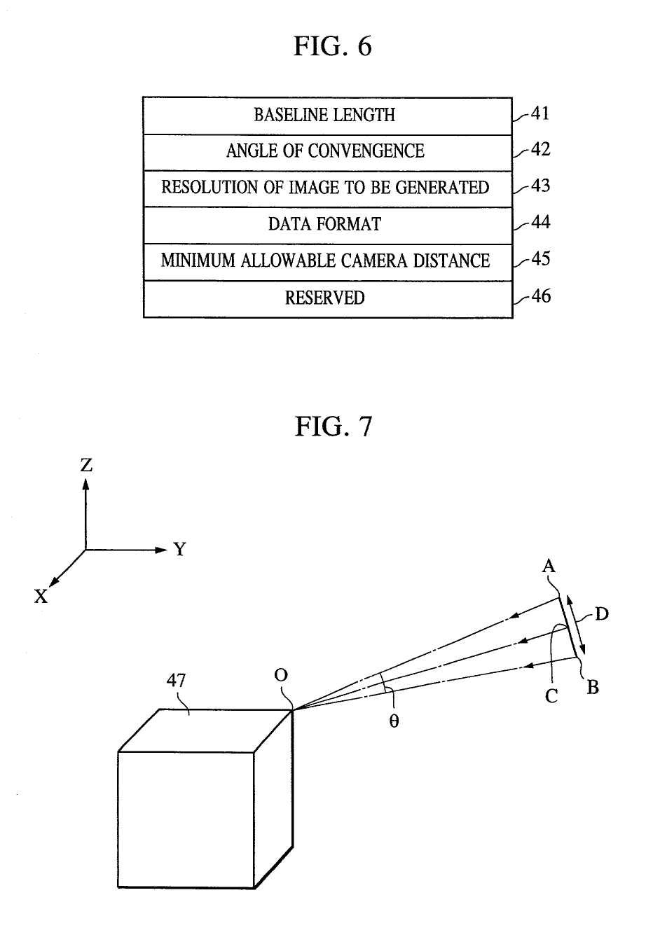

The image generation information is necessary to generate two stereoscopic images by means of a rendering process. As shown in FIG. 6, the image generation information includes data indicating baseline length 41, the angle of convergence 42, the resolution 43 of an image to be generated, the data format 44 of stereoscopic image data, the minimum allowable camera distance 45, and a reserved field 46 for describing other information. In the present embodiment, optimum values associated with image generation information to be converted from display device information are described in a table for all possible 3D display devices and stored in the display device information converter 10. Instead of using the look-up table, the conversion from display device information into image generation information may also be performed by calculation according to a formula representing the mapping from display device information shown in FIG. 2 to image generation information.

In the next step S11, it is determined whether the VRML format is specified by the data described in the field of “requested data format” 25 in the data request packet. In the case where the VRML format is requested, that is, in the case where it is requested that 3D data is directly acquired, the process proceeds to step S14, because the data is of a 3D scene.

On the other hand, if the answer in step S11 is negative (no), the process proceeds to step S12 to generate a 3D scene by means of a rendering process. That is, the 3D scene data which has been read, in step S9, by the 3D scene generator 9 is rendered on the basis of the viewpoint information 26 described in the data request packet and also on the basis of the image generation information described above, so as to generate two-viewpoint stereoscopic images.

More specifically, in the rendering process, virtual cameras are placed in 3D scene data, that is, in a 3D space in which the 3D scene data exists, and a 2D space is taken by the virtual cameras thereby obtaining a 2D image. In this process, to render the stereoscopic image, two virtual cameras are placed at left and right viewpoints, respectively. The viewpoint information 26 includes information about the coordinates of the viewpoints in the 3D scene and the viewing directions. On the basis of this viewpoint information 26 and also on the basis of the baseline length 41 and the angle of convergence 42 described in the image generation information, the three-dimensional locations of the virtual cameras and the directions thereof are determined when two-viewpoint stereoscopic images are generated by means of rendering.

That is, as shown in FIG. 7, when the location of an object 47 whose image is to be taken is representatively indicated by a point 0, the location of a viewpoint included in the viewpoint information is represented by point C, the viewing direction is represented by line CO, the baseline length is represented by D, and the angle of convergence is represented by θ, rendering is performed by assuming that two virtual cameras are disposed at points A and B, respectively. That is, the cameras at points A and B are placed so as to be aimed at point 0. If the midpoint of segment AB is denoted by C, then θ=∠AOB, ∠AOC =∠BOC =θ/2. If a horizontal plane in the 2D space is denoted by XY plane, the Z coordinates of points A and B become equal to the Z coordinate of point C. That is, the segment becomes parallel to the XY plane.

In the rendering process, a 3D scene at a location nearer to the camera than the minimum allowable camera distance 45 described in the image generation information has a parallax greater than the maximum allowable parallax. Therefore, rendering of 3D scenes at distances smaller than the minimum allowable camera distance 45 is prohibited. In addition, it is desirable to convert 3D scenes at distances smaller than the minimum allowable camera distance 45 into a semitransparent fashion so that the maximum parallax becomes inconspicuous.

In step S13, in accordance with the data format 37 described in the image generation information, the stereoscopic image data converter 8 converts the format of the two images obtained by means of rendering at two viewpoints. In the case where a compression scheme is specified, the image data is compressed. In step S14, the resultant image data is returned to the database client 1a or 1b.

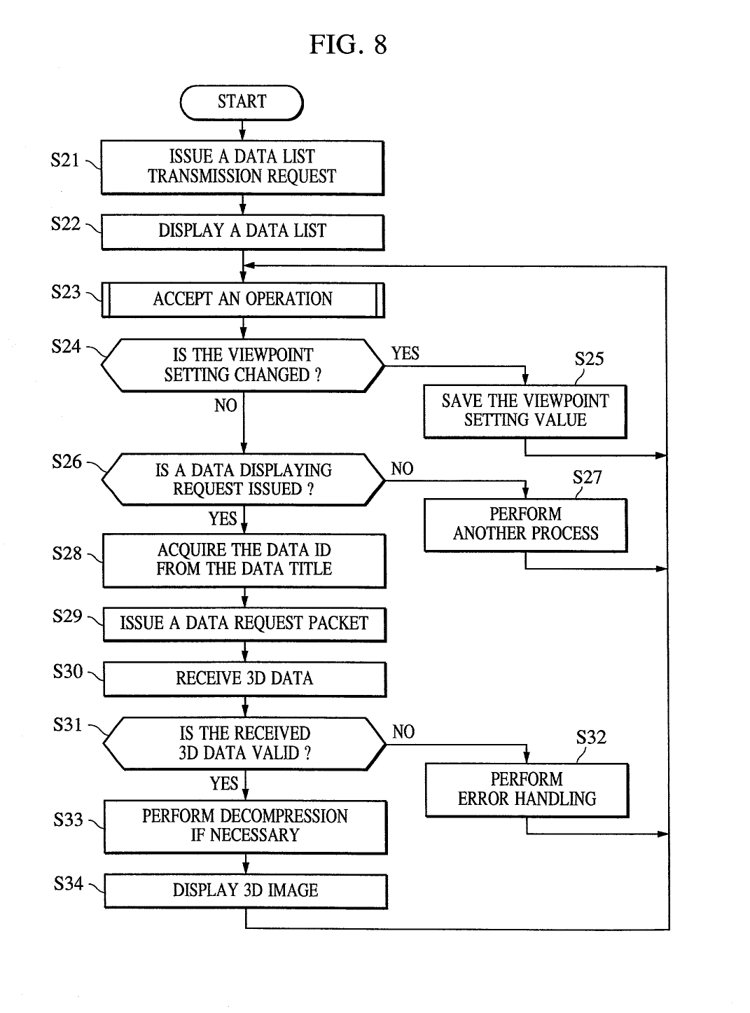

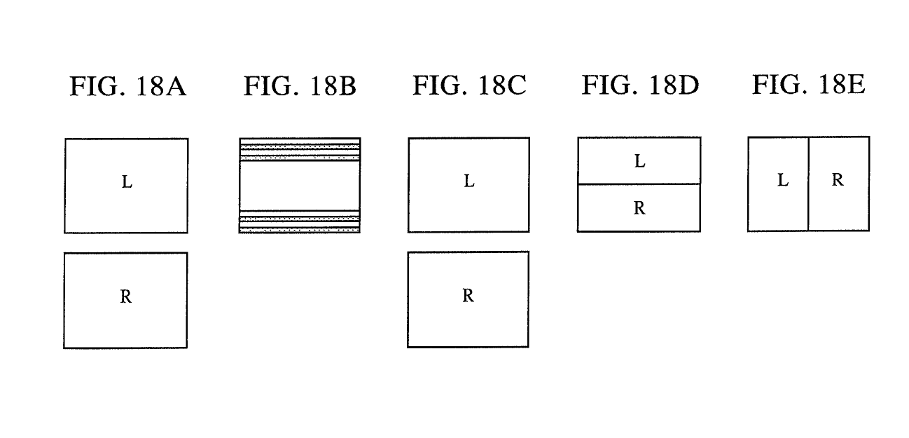

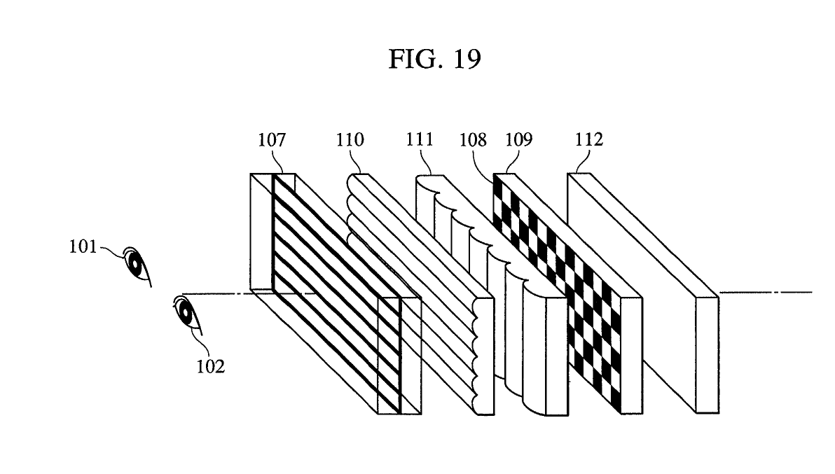

In the case where a line-sequential format is specified by the data in the field of data format 37, if compression using DCT, such as JPEG compression, is performed in a direct fashion, it becomes impossible to clearly separate left and right images from each other when the image data is decompressed. In such a case, to avoid the above problem, lines are re-arranged such that even numbered and odd-numbered lines are separately extracted and left and right images are created therefrom (FIG. 18E), and then compression is performed. When decompression is performed, the process is performed in a reverse manner. [0071] FIG. 8 is a flow chart illustrating an operation of the database client 1a or 1b.

In step S21, a list request packet is issued to the database server 3. In the next step S22, a list of 3D data stored in the data management unit 11 is acquired. The list of data titles 22b included in the acquired list response packet is displayed on the 3D data selecting/displaying unit 16a or 16b and corresponding data IDs are stored in the 3D data selecting/displaying unit 16a or 16b.

Thereafter, in step S23, an operation of a user is accepted. Then, in the following step S24, it is determined whether the viewpoint has been set or changed by the viewpoint setting/changing unit 15a or 15b.

If the answer is positive (yes), the viewpoint information changed in step S25 is stored in the device information management unit 13a or 13b. Thereafter, the process returns to step S23.

However, if the answer in step S24 is negative (no), the default values are maintained and the process proceeds to step S26. In step S26, the data tiles 22b are displayed in the form of a list on the data selecting/displaying unit 14. Furthermore, it is determined whether a user has selected a data title 22b and issued a request for displaying the data corresponding to the selected data title.

If the answer is negative (no), the process proceeds to step S27 to perform another process. The process then returns to step S23. However, if the answer is positive (yes), the process proceeds to step S28 to acquire the data ID 22a corresponding to the data title 22b. In the following step S29, the display device information 24 stored in the device information management unit 13a or 13b and the viewpoint information 26 stored in the viewpoint setting/changing unit 15a or 15b are read and a data request packet is generated by adding the display device information 24 and the viewpoint information 26 to the data request 23. The generated data request packet is issued to the database server 3. Then, in step S30, 3D data is received and acquired from the database server 3.

In the next step S31, it is determined whether the acquired 3D data has a valid format. If the answer in step S31 is negative (no), the process proceeds to step S32 to perform error handling. Thereafter, the process returns to step S23. If the answer in step S31 is positive (yes), the process proceeds to step S33 to perform decompression, if necessary. Then in step S34, the image data is displayed on the first or second 3D display device 5a or 5b.

In this first embodiment, as described above, the database client 1a or 1b selects a desired 3D scene stored in the data management unit 11 and issues, to the 3D database server 3, a request for the 3D scene together with additional information about the data format and the maximum allowable parallax of the 3D display device 5a or 5b. In response, the 3D database server 3 renders the stereoscopic image and returns the resultant data. In the above process, the rendering is performed using the image generation information indicating the optimum convergence angle and the baseline length for the corresponding 3D display device 5a or 5b thereby making it possible to flexibly deal with various types of stereoscopic image formats and thus deal with various 3D display devices.

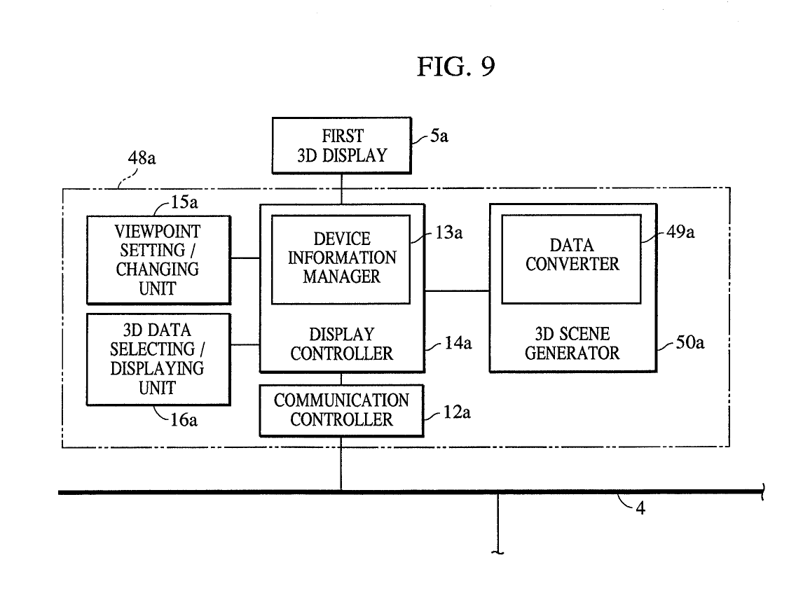

FIG. 9 illustrates a first modification of the first embodiment described above. In this first modification, a 3D scene generator 50a including a stereoscopic image data converter 49a is provided in a first database client 48a having a sufficiently high capability of rendering. In such a case, the VRML format may be specified as the requested data format 25 issued to the database server 3, and the database client 48a may perform rendering to create a stereoscopic image from an image in the VRML format. In this case, thus, the data transmitted via the network 4 is not stereoscopic image data created by means of rendering but VRML data.

In the embodiment described above, the scene is assumed to be of a still image. However, the scene may also be of a moving image. In the case of a moving image, the stereo image data 33 (FIG. 3D) in the data response packet is transmitted in the form of a stereoscopic image stream data. Stereoscopic image stream data can be dealt with in a similar manner to ordinal moving image stream data except for the upper-and-lower two-image format (FIG. 18D) and the left-and-right two-image format (FIG. 18E). In the case of a line-sequential moving image (FIG. 18B), lines are rearranged in a similar manner to a still image. In the case of the two-input format (FIG. 18A) or the page-flipping format (FIG. 18C), the image data is regarded as to represent a single large-size image obtained by combining two images, and the image is separated into the original two images by a receiving device.

Even in the case where a normal two-dimensional display device is connected instead of the stereoscopic display device, an image may be displayed by specifying a 2D format. In this case, rendering process is performed only for one viewpoint described in the viewpoint location information.

In the case where a stereoscopic display device other than the device designed to display two-viewpoint images, such as a hologram device, is used, a 2D scene is rendered or converted into a data format suitable for that stereoscopic display device, and the resultant data is returned.

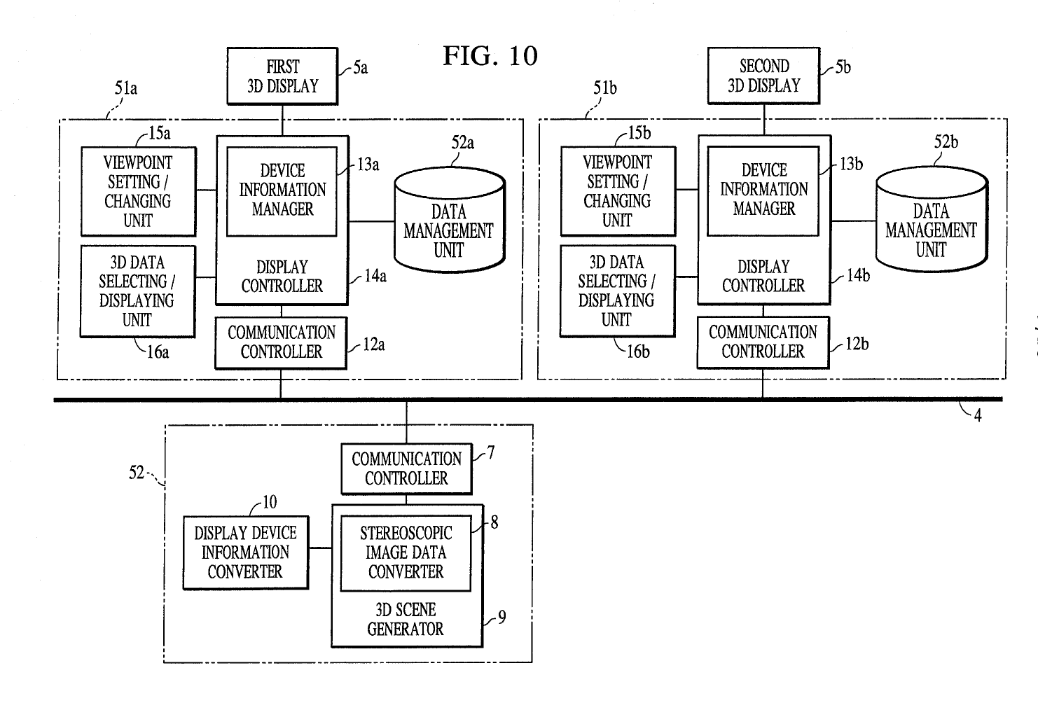

FIG. 10 illustrates a second embodiment which is a modification of the first embodiment. In this second embodiment, instead of providing the database managing unit in the database server 52, database managing units 52a and 52b are provided in the first and second database clients 51a and 51b, respectively. A 3D scene data is transmitted from the first or second database client 51a or 51b to the database server 52, and the rendering is performed by the first or second database client 51a or 51b.

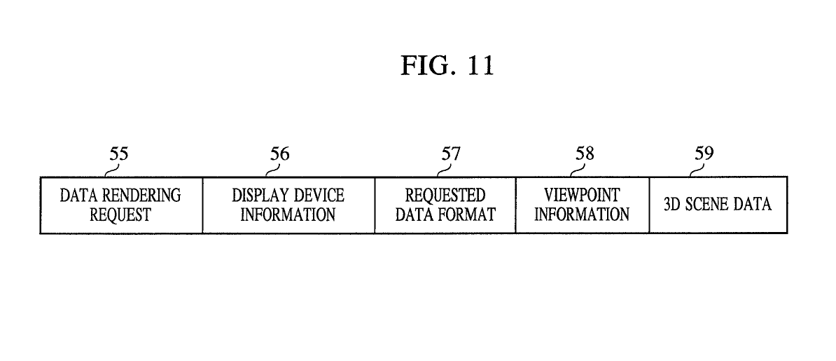

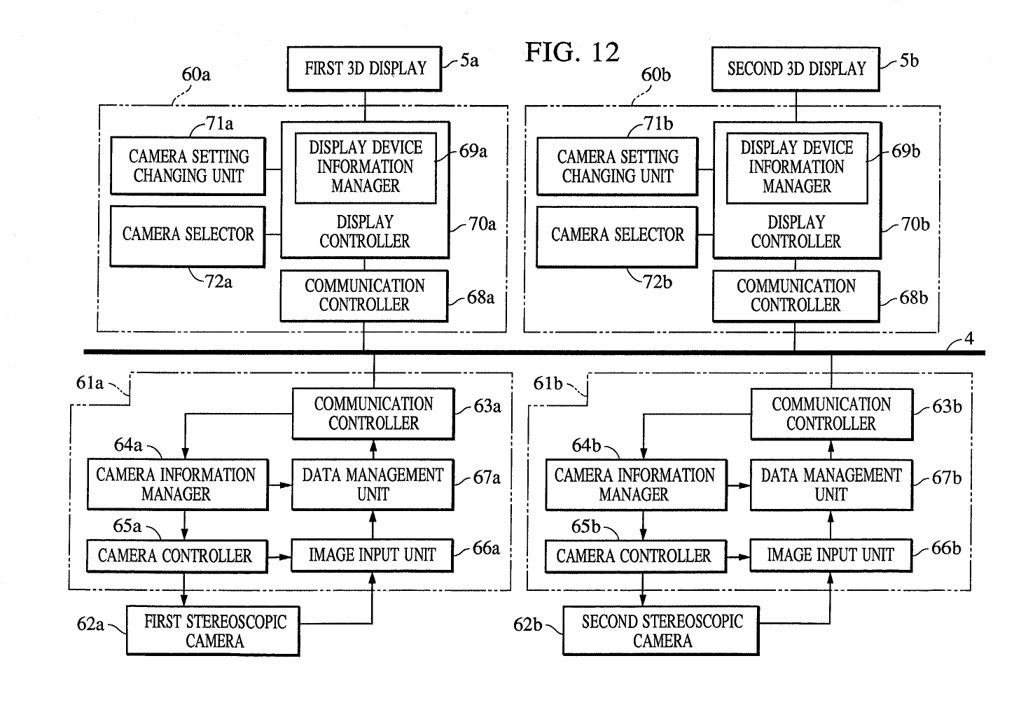

That is, in this second embodiment, instead of a data request packet, a data rendering request packet such as that shown in FIG. 11 is issued by the first or second database client 51a or 51b to the database server 52. That is, the data rendering request packet includes fields for describing the type of packet 55 which is a data rendering request in this case, display device information 24, a requested data format 25, viewpoint information 26, and 3D scene data 59. The 3D data selecting/displaying unit 16a or 16b is used to select 3D scene data to be transmitted to the database server 52.

In the case of a moving image scene, a packet, including a packet type field indicating that the packet is a viewpoint changing request and also including a field in which viewpoint information, is created and viewpoint information is successively transmitted.

In the second embodiment, as described above, display device information needed in generating a pair of stereoscopic images in a format corresponding to the display device is stored in the first and second database clients 51a and 51b, and, when the database server 52 generates a pair of stereoscopic images by rendering 3D data received from the first or second database client 51a or 51b, the display device information is converted into stereoscopic image generation information needed in generation of the stereoscopic images thereby allowing the pair of stereoscopic images to be generated in the optimum fashion. This makes it possible to flexibly deal with various types of 3D display devices according to various stereoscopic image formats. Furthermore, because the rendering process is performed not by the database client 51a or 51b but by the database server 52 disposed separately from the database clients 51a and 51b, the processing load is distributed. In particular, rendering imposes a large load upon the process. If a plurality of database servers are provided, and if a database server which currently has a low load is searched for and is used to perform rendering, the load in the rendering process can be distributed even in a system in which various types of 3D display devices different from each other in terms of the stereoscopic image format are connected to each other, without concern for the difference in the display type.

Now, a third embodiment of the present invention is described.

FIG. 12 is a diagram illustrating a third embodiment of a stereoscopic image system according to the present invention. In this stereoscopic image display system, first and second database clients 60a and 60b and first and second 3D camera servers 61a and 61b are connected to each other via a network 4. First and second 3D display devices 5a and 5b are connected to the first and second database clients 60a and 60b, respectively, and first and second stereoscopic cameras 62a and 62b are connected to the first and second 3D camera servers 61a and 61b, respectively.

Each of the 3D camera servers 61a and 61b includes a communication controller 63a or 63b serving as an interface with the network 4; a camera information manager 64a or 64b for managing camera information; a camera controller 65a or 65b for controlling the stereoscopic camera 62a or 62b in accordance with the camera information provided by the camera information manager 64a or 64b; an image input unit 66a or 66b for inputting an image taken by the stereoscopic camera 62a or 62b; and a data management unit 67a or 67b for managing the image data input via the image input unit 66a or 66b and the camera information managed by the camera information manager 64a or 64b. Various parameters (baseline length, angle of convergence, focusing condition) associated with the stereoscopic camera 62a or 62b are properly set in accordance with a request issued from the database client 60a or 60b, and an image taken via the stereoscopic camera 62a or 62b is transmitted, after being compressed, to the database client 60a or 60b.

Each of the stereoscopic camera 62a and 62b includes two camera lens systems, wherein the baseline length, the angle of convergence, the focusing condition, the zooming factor can be set or changed in accordance with a request issued by the camera controller 65a or 65b .

The baseline length, the angle of convergence, the focal length of the lenses, the capability of automatic focusing, and the capability of zooming may be different between the stereoscopic cameras 62a and 62b. Each of the stereoscopic cameras 62a and 62b is capable of outputting image data in digital form.

Each of the database clients 60a and 60b includes a communication controller 68a or 68b serving as an interface with the network 4; a display controller 70a or 70b including a display device information manager 69a or 69b; a camera setting changing unit 71a or 71b for changing the setting of the camera; a camera selector 72a or 72b for selecting a desired stereoscopic camera from a plurality of stereoscopic cameras. Each of the database clients 60a and 60b displays an image in a stereoscopic fashion by controlling the first or second 3D display device 5a or 5b, transmitting a request packet to the 3D camera server 61a or 61b, and decompressing a received stereoscopic image.

Each of the 3D camera servers 61a and 61b accepts, via the network 4, a request packet such as a stereoscopic image request issued by the database client 60a or 60b, sets the parameters associated with the operation of taking an image in an optimum manner depending upon the database client 60a or 60b, and outputs a stereoscopic image.

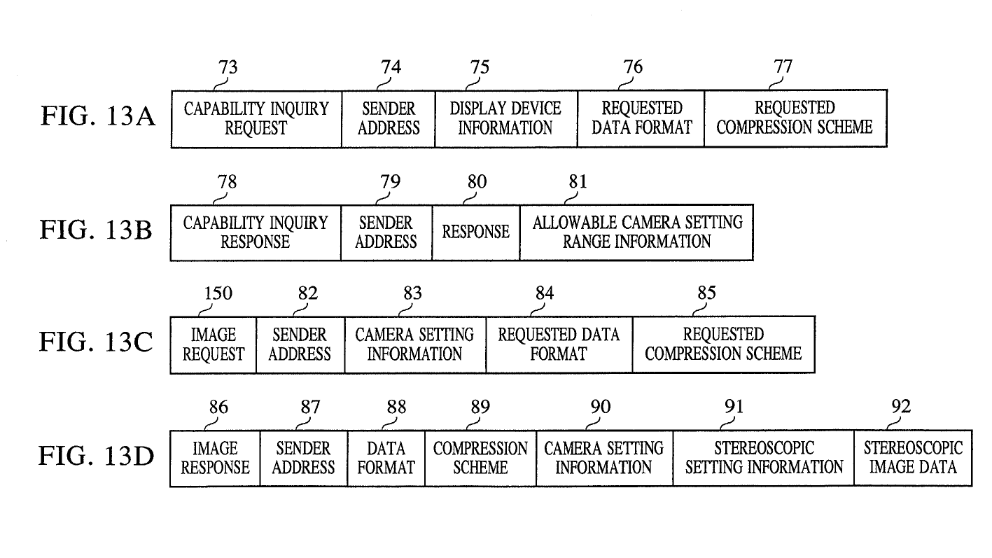

FIG. 13 illustrates packet formats of request and response packets transmitted between the database client 60a or 60b and the 3D camera server 61a or 61b.

In a first field of each packet, the type of that packet is described. There are four types of packets formats as shown in FIGS. 13A to 13D.

FIG. 13A illustrates a format of a camera capability inquiry request packet. The packet includes a field for describing the packet type 73 in which, in this specific case, data is written so as to indicate that the packet is a capability inquiry request. The packet further includes fields for describing a sender address 74 identifying a sender of the request packet, display device information 75, a requested data format 76 specifying a stereoscopic image format of a stereoscopic image, and a requested compression scheme 77 specifying a requested image compression scheme.

The display device information is described in a data format similar to that according to the first embodiment (FIG. 4). In the field of requested data format 76, a format ID is described to specify a stereoscopic image format shown in FIG. 2.

FIG. 13B illustrates a packet format of a response packet transmitted in response to a camera capability inquiry request. The packet includes a packet type field 78 in which, in this specific case, data is written so as to indicate that the packet is a capability inquiry response. The packet further includes fields for describing a sender address 79 identifying a sender of the response packet, response information 80 in which “OK” or “NG” is written to indicate whether the camera has a requested capability, and an allowable camera setting range information 81 in which camera capability information is described.

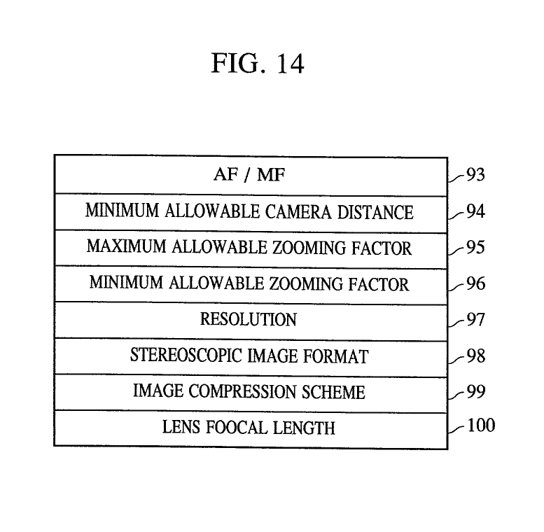

More specifically, as shown in FIG. 14, the allowable camera setting range information includes an AF/MF information 93 indicating whether focus is adjusted automatically or manually, a minimum allowable camera distance 94 indicating a minimum allowable distance of the camera, a maximum allowable zooming factor 95 indicating a maximum allowable zooming factor, a minimum allowable zooming factor 96 indicating a minimum allowable zooming factor, resolution information 97 indicating all allowable resolutions of an image taken by the camera and output, stereoscopic image format information 98 indicating a stereoscopic image format available for outputting an image, image compression scheme information 99 indicating an available image compression scheme, and focal length information 100 indicating the focal length of the lens. In the case where the camera has a zooming capability, the focal length described in the focal length information 100 indicates the focal length when the zooming factor is set to 1.

FIG. 13C illustrates a format of an image request packet. The packet includes a packet type field 150 in which, in this specific case, data is written so as to indicate that the packet is an image request packet. The packet further includes fields for describing a sender address 82 identifying a sender of the request packet, camera setting information 83 indicating requested values associated with the zooming and focusing, a requested data format 84 specifying a stereoscopic image format, and a requested compression scheme 85 specifying a requested image compression scheme.

FIG. 13D illustrates a packet format of a response packet which is returned in response to an image request packet. The packet includes a packet type field 86 in which, in this specific case, data is written so as to indicate that the packet is an image response packet. The packet further includes fields for describing a sender address 87 identifying a sender of the response packet, The packet further includes a data format 88 indicating the format of the image data, a compression scheme 89 indicating the compression scheme of the image data, camera setting information 90 indicating the zooming factor and the focusing value employed when the stereoscopic image was taken, stereoscopic image setting information 91 indicating the baseline length and the angle of convergence employed when the stereoscopic image was taken, and stereoscopic image data in the above data format compressed in the above compression scheme.

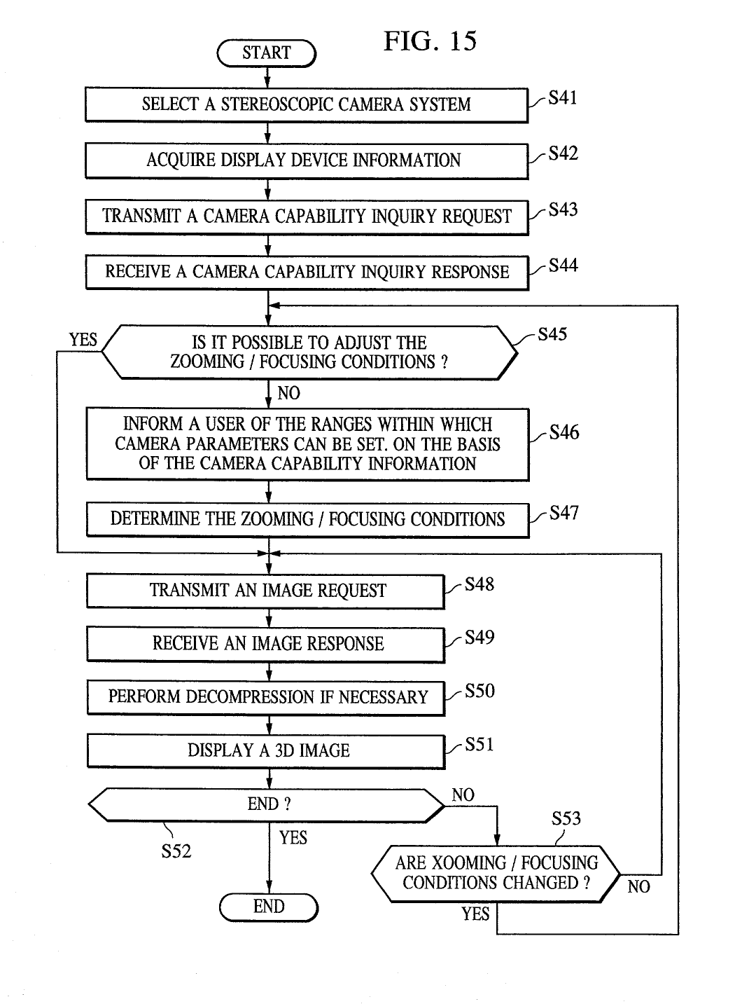

FIG. 15 is a flow chart illustrating an operation of the first database client 60a. Although in this second embodiment the operation is described only for the first database client 60a, the operation of the second database client 60b is similar to that of the first database client 60a.

When the database client 60a or 60b starts an operation of taking an image, a user selects, in step S41, a 3D camera server used to take an image from a plurality of 3D camera servers present on the network 4, using a camera selector 72a. Note that addresses of respective 3D camera servers on the network 4 have been acquired in advance. In this specific example, a first 3D camera server 61a is selected.

In the next step S42, display device information is acquired from the display device information manager 69a. In the following step S43, a camera capability inquiry request packet is generated on the basis of the information described above and transmitted to the first 3D camera server 61a. Thereafter, in step S44, a response packet is received from the first 3D camera server 61a. Then, in step S45, it is determined whether the zooming range, the focusing range, and the AF/MF setting of the stereoscopic camera 62a can be changed. If the answer is positive (yes), the process proceeds to step S48. However, if the answer is negative (no), the process proceeds to step S46 to inform the user of the allowable setting ranges of various parameters such as the zooming factor and the focusing value which can be changed via the camera setting changing unit 71a. In step S47, the zooming factor and the focusing value are determined. Thereafter, the process proceeds to step S48. The camera setting changing unit 71a includes a graphical user interface (GUI) displayed on the display screen so that various kinds of data are presented to a user and so that the user can perform setting via the GUI.

In step S48, an image request packet is generated on the basis of the camera setting information 90, the compression scheme 89, and the data format 87 and the generated packet is transmitted to the 3D camera server 61a. In step S49, an image response packet is received. In the following step S50, the display controller 70a decompresses the stereoscopic image data in accordance with the data format 88 and the compression scheme 89 described in the image response packet. In the next step S51, the image data is displayed on the first 3D display device 5a so as to provide stereoscopic vision. The image response packet includes camera setting information 90 representing the camera setting employed when the image was taken and also includes stereoscopic image setting information 91 in addition to the above-described data format 88 and the compression scheme 89. The camera setting information 90 and the stereoscopic image setting information 91 are displayed on the display screen of the camera setting changing unit 71a.

In step S52, it is determined whether the user has ended the operation. If the answer is positive (yes), the process is ended. However, if the answer is negative (no), the process proceeds to step S53 to determine whether the zooming factor or the focusing value has been changed. If the answer is positive (yes), the process returns to step S45 to repeat the above-described steps from step S45. However, if the answer is negative (no), the process returns to step S48 to repeat the above-described steps from step S48.

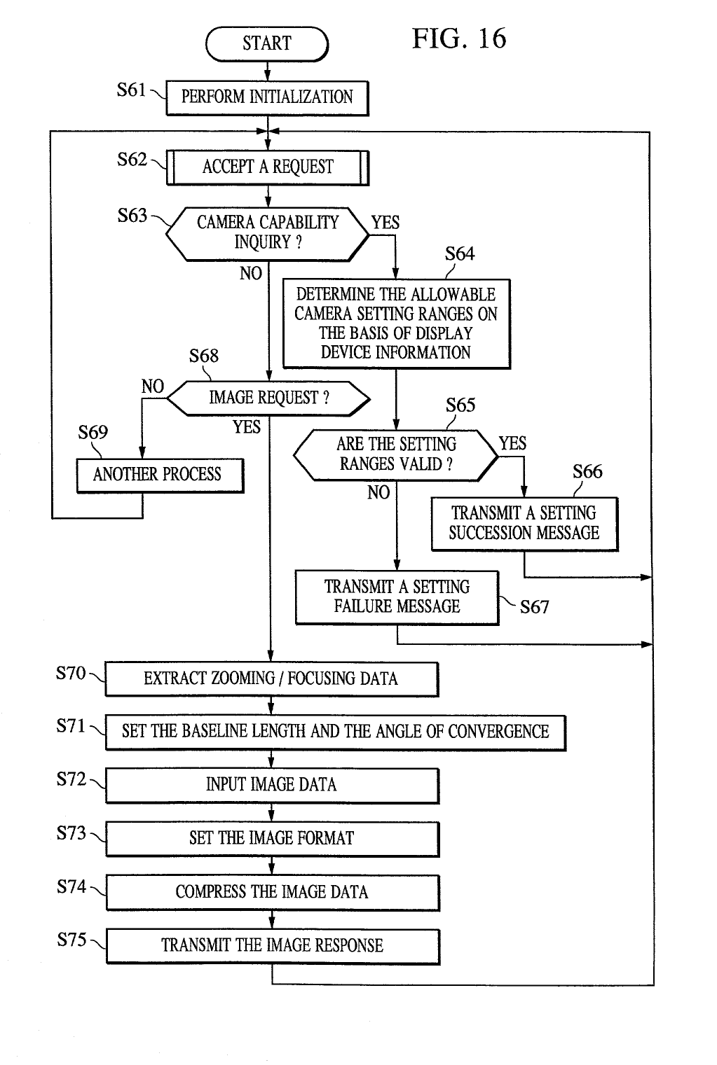

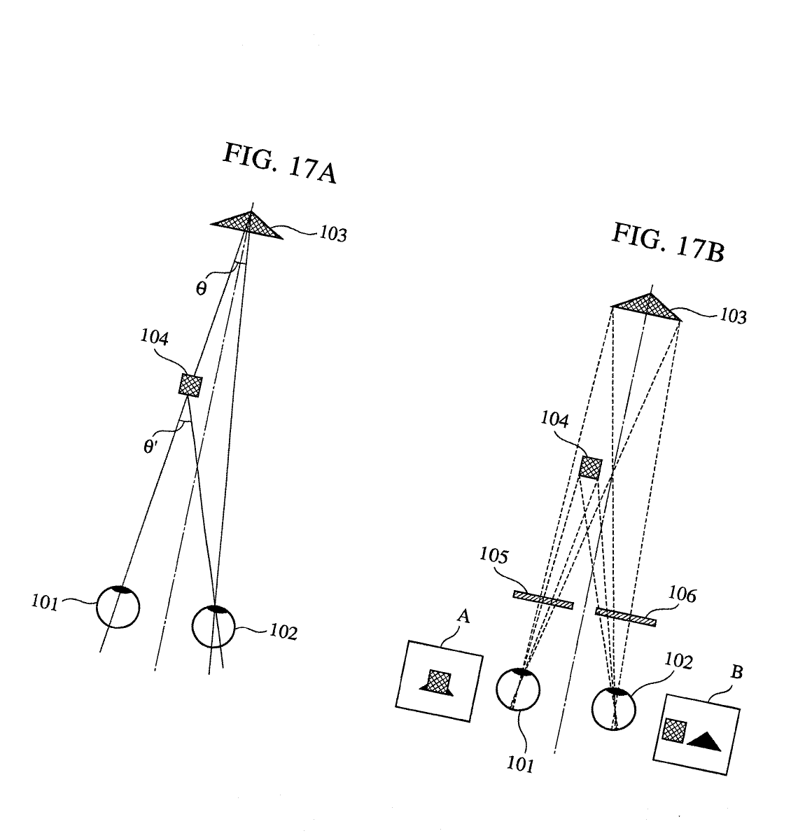

FIG. 16 is a flow chart illustrating an operation of the first 3D camera server 61a. Although in this third embodiment, the operation is described only for the first 3D camera server 61a, the operation of the second camera server 61b is similar to that of the first 3D camera server 61a.

When the operation of the first 3D camera server 61a is started, data representing the zooming factor, the focusing value, the baseline length, the angle convergence, etc., is initialized in step S61. In step S62, a request packet issued by the first database client 60a is accepted.

In step S63, it is determined whether a camera capability inquiry request packet has been received. If the answer is positive (yes), the display device information 75, the requested data format 76, and the requested compression scheme 77 described in the request packet are input to camera information manager 64a. Thereafter, the zooming range and the focusing range, which may vary depending upon the display device information 75, are determined thereby determining the allowable camera setting range information 81. Then in step S65, it is determined whether the setting ranges are valid. If the answer is positive (yes), an “MOK” message is transmitted in step S66. However, if the answer is negative (no), an “ING” message is transmitted in sep S67. In each case, the process returns to step S62.

The allowable camera setting range information 81, that is, the zooming range and the focusing range are determined not only on the basis of the display device information 75 but also taking into account the allowable setting range of the baseline length and the allowable setting range of the angle of convergence.

In the case where the answer in step S63 is negative (no), the process proceeds to step S68 to determine whether an image request packet has been received. If the answer is negative (no), the process proceeds to step S69 to perform another process. Thereafter, the process returns to step S62. However, if the answer in step S68 is positive (yes), the process proceeds to step S70. In step S70, the camera setting information 83, the requested data format 84, and the requested compression scheme 85 are read from the camera information manager 64a. In step S71, the optimum baseline length and the optimum angle of convergence are calculated on the basis of the zooming factor and the focus information. In accordance with the determined camera parameters, the camera controller 65a controls the stereoscopic camera 62a.

Thereafter, in step S72, left and right stereoscopic images in digital form are input via the image input unit 66a. In the next step S73, the data management unit 67a converts the input data into the requested data format 84. In step S74, if necessary, the image data is compressed in accordance with the requested compression scheme 85. In step S75, the image response packet is transmitted to the first database client 60a. Note that the camera setting information 90 and the stereoscopic image setting information 91 which were set when the image data was input are also included in the image response packet.

It is required to determine the optimum angle of convergence and the optimum baseline length in accordance with the focal length of the camera obtained from the zooming information and the focus information and also in accordance with the display device information. The correspondence among these parameters is stored in the form of a table or a formula in the data managing unit 67a so that the optimum angle of convergence and the optimum baseline length can be determined by means of retrieval from the table or by means of calculation.

In this third embodiment, as described above, the database client 60a or 60b transmits the display information 75 indicating the type and size of the stereoscopic display device to the 3D camera server 61a or 61b. The 3D camera server 61a or 61b determines stereoscopic image-taking information such as the baseline length and the angle of convergence on the basis of the display device information 75 and sets the baseline length and the angle of convergence of the stereoscopic camera 62a or 62b in accordance with the stereoscopic image-taking information. Image data is taken by the stereoscopic camera 62a or 62b and the resultant image data is transmitted to the database client 60a or 60b. This makes it is possible to flexibly deal with various types of stereoscopic image formats and thus deal with various types of 3D display devices.

Although in the third embodiment described above, the stereoscopic camera including two camera units is used, a camera including only a single imaging system may also be employed. In this case, for example, left and right images are taken alternately on a field-by-field basis. That is, there is no particular limitation in terms of the type of the camera as long as the camera is capable of outputting a pair of stereoscopic images in digital form.

As described above in detail, various kinds of device information needed in generation of image data are managed, and desired device information is converted into image generation information whereby desired image data is generated by rendering 3D data on the basis of the viewpoint information and the image generation information. This makes it is possible to flexibly deal with various types of stereoscopic image formats and thus deal with various types of 3D display devices.

Furthermore, device information needed in taking an image is stored in the 3D display device, and, when image data is taken, the image-taking conditions are determined on the basis of the device information so that the image is taken under the optimum conditions in terms of the angle of convergence and the baseline length. This makes it is possible to flexibly deal with various types of stereoscopic image formats and thus deal with various types of 3D display devices.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image display control apparatus comprising:
(a) display image generating means for generating a display image from three-dimensional image data; and
(b) device information acquiring means for acquiring device information associated with a display device,
wherein said display image generating means generates the display image in an image format corresponding to the device information acquired by said device information acquiring means.

2. An image display control apparatus, according to claim 1, further comprising data managing means for managing said three-dimensional image data.

3. An image display control apparatus, according to claim 1, further comprising data acquiring means for acquiring said three-dimensional image data from an external device.

4. An image display control apparatus, according to claim 1, further comprising:
conversion means for converting the device information acquired by said device information acquiring means into image generation information; and
viewpoint information acquiring means for acquiring viewpoint information associated with said display device,
wherein said display image generating means includes rendering means for generating a display image by rendering said three-dimensional image data on the basis of said image generation information and said viewpoint information.

5. An image display control apparatus, according to claim 4, wherein the display image generated by said rendering means is a stereoscopic image for providing stereoscopic vision.

6. An image display control apparatus, according to claim 5, wherein said stereoscopic image is a two-viewpoint image.

7. An image display control apparatus, according to claim 4, wherein the display image generated by said rendering means is a single-viewpoint image.

8. An image display control apparatus, according to claim 1, wherein said display image generating means acquires a three-dimensional scene serving as a display image directly from said three-dimensional image data.

9. An image display control apparatus, according to claim 1, wherein said device information includes at least information about a device type, a screen size, a screen resolution, a data format, an optimum observation distance, and a maximum allowable parallax.

10. An image display control apparatus comprising:
(a) device information managing means for managing device information associated with a display device; and
(b) image data acquiring means for acquiring, from an external device, image data corresponding to device information managed by said device information managing means.

11. An image display control apparatus according to claim 10, further comprising:
data managing means for managing three-dimensional image data; and
transmission means for transmitting said device information and said three-dimensional image data to said external device.

12. An image display control apparatus according to claim 10, wherein the display image acquired from said external device is a stereoscopic image for providing stereoscopic vision.

13. An image display control apparatus according to claim 12, wherein said stereoscopic image is a two-viewpoint image.

14. An image display control apparatus according to claim 10, wherein the image data acquired from said external device is a single-viewpoint image.

15. An image display control apparatus according to claim 10, wherein the image data acquired from said external device is three-dimensional scene data.

16. An image display control apparatus according to claim 10, wherein said device information includes at least information about a device type, a screen size, a screen resolution, a data format, an optimum observation distance, and a maximum allowable parallax.

17. An image display control apparatus comprising:
(a) a camera device for taking image data;
(b) device information acquiring means for acquiring device information associated with a display device; and
(c) image-taking information acquiring means for acquiring image-taking information corresponding to said device information,
wherein said display image generating means generates a display image in accordance with the image-taking information acquired by said image-taking information acquiring means.

18. An image display control apparatus comprising:
(a) device information managing means for managing device information associated with a display device;
(b) a camera device selecting means for selecting a particular camera device from a plurality of camera devices;
(c) transmitting means for transmitting, to an external device, said device information and the selection information indicating the selected camera device; and
(d) image data acquiring means for acquiring, from said external device, image data taken by said particular camera device.

19. An image display control apparatus according to claim 18, wherein the image data taken by said camera device is data of a stereoscopic image.

20. An image display control apparatus according to claim 19, wherein said stereoscopic image is a two-viewpoint image.

21. An image display control apparatus according to claim 18, wherein image data taken by said camera device is data of a single-viewpoint image.

22. An image display control apparatus according to claim 18, wherein image data taken by said camera device is data of a still image.

23. An image display system comprising: a display device for displaying image data; a first image display control apparatus which is connected to said display device and which is operated by an user; and a second image display control apparatus which is connected to said first image display control apparatus via a predetermined communication network and which performs predetermined image processing in response to a request issued by said first image display control apparatus, wherein
said first image display control apparatus comprises: device information managing means for managing device information associated with said display device; and image data acquiring means for acquiring image data in a format depending according to said device information from said second image display control apparatus,
said second image display control apparatus comprises: display image generating means for generating display image from three-dimensional image data; and device information acquiring means for acquiring device information associated with said display device, and
said display image generating means generates the display image in the image format according to said device information.

24. An image display system according to claim 23, wherein said first image display control apparatus further comprises data managing means for managing said three dimensional image data, and said second image display control apparatus further comprises data acquiring means for acquiring said three-dimensional image data from said first image display control apparatus.

25. An image display system according to claim 23, wherein said second image display control apparatus further comprises data managing means for managing said three-dimensional image data.

26. An image display system according to claim 25, wherein said second image display control apparatus further comprises conversion means for converting device information acquired by said device information acquiring means into image generation information and viewpoint information acquiring means for acquiring viewpoint information associated with the display device, and wherein said display image generating means comprises rendering means for generating display image by rendering said three-dimensional image data on the basis of said image generation information and the viewpoint information.

27. An image display system according to claim 26, wherein the display image generated by said rendering means is a stereoscopic image for providing stereoscopic vision.

28. An image display system according to claim 27, wherein said stereoscopic image is a two-viewpoint image.

29. An image display system according to claim 26, wherein the display image generated by said rendering means is a single-viewpoint image.

30. An image display system according to claim 23, wherein said display image generating means acquires a three-dimensional scene serving as a display image directly from said three-dimensional image data.

31. An image display system according to claim 23, wherein said device information includes information about a device type, a screen size, a screen resolution, a data format, an optimum observation distance, and a maximum allowable parallax.

32. An image display system comprising; a display device for displaying image data; a first image display control apparatus which is connected to said display device and which is operated by an user; a second image display control apparatus which is connected to said first image display control apparatus via a predetermined communication network and which performs a predetermined image taking process in response to a request issued by said first image display control apparatus,
said first image display control apparatus comprising:
device information managing means for managing device information associated with said display device;
a camera device selecting means for selecting a camera device for taking image data from a plurality of camera devices;
transmitting means for transmitting said device information and the selection information indicating the selected camera device to said second image display control apparatus; and
image data acquiring means for acquiring image data taken by the selected camera device from said second image display control apparatus,
said second image display control apparatus comprising:
a camera device for taking image data;
device information acquiring means for acquiring device information associated with said display device; and p2 image-taking information acquiring means for acquiring image-taking information corresponding to said device information,
wherein said display image generating means generates a display image in accordance with the image-taking information acquired by said image-taking information acquiring means.

33. An image display system according to claim 32, wherein the image data taken by said camera device is data of a stereoscopic image.

34. An image display system according to claim 33, wherein said stereoscopic image is a two-viewpoint image.

35. An image display system according to claim 32, wherein the image data taken by said camera device is data of a single-viewpoint image.

36. An image display system according to claim 32, wherein the image data taken by said camera device is data of a still image.

37. A method of displaying, on a display device, image data acquired in response to an acquisition request issued by a user by operating a first image display control apparatus to a second image display control apparatus, said method comprising:
a step performed by said first image display control apparatus, said step including the steps of:
managing device information associated with said display device; and
acquiring image data in a format according to said device information from said second image display control apparatus; and
a step performed by said second image display control apparatus, said step including:
generating a display image from three-dimensional image data; and
acquiring device information associated with said display device,
wherein in said display image generating step, the display image is generated in an image format according to said device information.

38. A method of displaying image data, according to claim 37, wherein said first image display control apparatus manages said three-dimensional image data, and said second image display control apparatus acquires said three dimensional image data from said first image display control apparatus.

39. A method of displaying image data, according to claim 37, wherein said second image display control apparatus manages said three-dimensional image data.

40. A method of displaying image data, according to claim 37, wherein the step performed by said second image display control apparatus further comprises the steps of: converting said device information into image generation information; and acquiring viewpoint information associated with three-dimensional image data, and wherein in said display image generating step, the display image is generated by rendering said three-dimensional image data on the basis of said image generation information and said viewpoint information.

41. A method of displaying image data, according to claim 40, wherein the display image generated by means of said rendering is a stereoscopic image for providing stereoscopic vision.

42. A method of displaying image data, according to claim 41, wherein said stereoscopic image is a two-viewpoint image.

43. A method of displaying image data, according to claim 37, wherein the display image generated by means of rendering is a single-viewpoint image.

44. A method of displaying image data, according to claim 37, wherein in said display image generating step, a three-dimensional scene is acquired as the display image directly from said three-dimensional image data.

45. A method of displaying image data, according to claim 37, wherein said device information includes at least information about a device type, a screen size, a screen resolution, a data format, an optimum observation distance, and a maximum allowable parallax.

46. A method of displaying, on a display device, image data acquired in response to an image-taking request issued by a user by operating a first image display control apparatus to a second image display control apparatus, said method comprising:
a step performed by said first image display control apparatus, said step including the steps of:
managing device information associated with said display device;
selecting a camera device for taking image data from a plurality of camera devices;
transmitting said device information and the selection information indicating the selected camera device to said second image display control apparatus; and
acquiring image data taken by the selected camera device from said second image display control apparatus; and
a step performed by said second image display control apparatus, said step comprising the steps of:
preparing a camera device for taking image data, and acquiring device information of said display device; and
acquiring image-taking information corresponding to said device information;
wherein in said display image generating step, the display image is generated in an image format according to said image-taking information.

47. A method of displaying image data, according to claim 46, wherein the image data taken by said camera device is data of a stereoscopic image.

48. A method of displaying image data, according to claim 47, wherein said stereoscopic image is a two-viewpoint image.

49. A method of displaying image data, according to claim 46, wherein the image data taken by said camera device is data of a single-viewpoint image.

50. A method of displaying image data, according to claim 46, wherein the image data taken by said camera device is data of a still image.
